(19) United States
(12) Patent Application Publication
(10) Pub. No.: US 2015/0281606 A1
(43) Pub. Date: Oct. 1, 2015

(54) DARK SIGNAL MODELING

(71) Applicant: Samsung Electronics Co., Ltd., Suwon-Si (KR)

(72) Inventors: Tomer LIVNEH, Ramat Gan (IL); Dmitry USENKO, Ramat Gan (IL)

(73) Assignee: SAMSUNG ELECTRONICS CO., LTD., Suwon-Si (KR)

(21) Appl. No.: 14/231,038

(22) Filed: Mar. 31, 2014

(51) Int. Cl. H04N 5/361; H04N 5/378; H04N 5/376; H04N 5/335

(52) U.S. Cl. CPC H04N 5/361; H04N 5/335; H04N 5/378; H04N 5/3765

(57) ABSTRACT

A method of compensating for dark signal in an image signal, the method including generating a dark signal model from a dark signal measurement, the dark signal being a digital signal representing a dark frame captured by an image sensor when shielded from exposure to light; and estimating the dark signal present in an object signal using the dark signal model, the object signal being a digital signal representing an object frame captured by the image sensor when exposed to light.

### BACKGROUND

An image sensor is a semiconductor device that may include a pixel array configured to convert optical information into electric signals. Examples of image sensors may include charge coupled device (CCD) image sensors and complementary metal-oxide semiconductor (CMOS) image sensors. Image sensors may be utilized in various electronic devices such as digital cameras.

The image sensor may generate current by accumulating photons due to light incident on pixels in the pixel array. In addition to electrons collected due to photons of light, a parasitic reverse bias leakage current, known as a dark current, may flow through the pixels even when no photons are entering the device due to thermal fluctuations of charge carriers causing the generation of electrons and holes within a depletion region of the image sensor. The dark current may generate a dark signal that imparts noise into an image signal by offsetting current levels associated with an image captured by the image sensor.

If a magnitude of the dark current is known, the noise may be corrected by subtracting the dark signal from a signal output by the image sensor to produce the image signal. A conventional approach to measure the dark current is based on shielding certain pixels from light, such as at the peripheral of the image sensor, and measuring the current produced by these pixels which are not exposed to light. However, the dark current may vary depending on various parameters. For example, the dark current may vary based on temperature and ground voltage of the pixels. Because pixels at different locations in the image sensor may have different parameters (e.g., temperatures and ground voltages), a different dark current may flow through different pixels. Therefore, the dark current may be non-uniform. This non-uniformity, often called “Dark shading”, may result in the dark current measured at the periphery being unrepresentative of the dark current flowing elsewhere in the image sensor.

To compensate for dark shading, a conventional approach may include capturing two images from the image sensor and subtracting one of the images from the other image. More specifically, the image sensor may capture a first image at a time a mechanical shutter is closed to measure the dark signal produced by pixels located both inside and outside of the periphery of the image sensor. The image sensor may also capture a second image of an object at a time the mechanical shutter is open and subtract the first image from the second image. However, this approach, utilizes two image signals which may each contain noise, therefore, noise caused by phenomena other than dark current may be increased. Moreover, because two images are captured and read, a frame buffer may be required to store the first image and additional time may be required to perform the imaging operation. In high definition image sensors, the inclusion of a frame buffer sufficient to store an image may significantly increase a size and cost associated with the image sensor.

Conventional approaches have attempted to reduce the required size of the frame buffer by downsizing the frame and utilizing interpolation when correcting the image signal. However, while the size of the frame buffer may be reduced a frame buffer may still be required. Moreover, interpolation errors and artifacts may appear when interpolating the downsized frame.

Conventionally, to alleviate the need for a frame buffer and/or a mechanical shutter, an image sensor may be initially calibrated upon production to generate a dark shading model that may be utilized to correct subsequently captured images. However, the effects of dark shading may vary significantly in different samples of the same image sensors, requiring a custom calibration of each sample. This calibration may require having the image sensor operate at a steady state temperature while capturing a dark frame and determine the associated dark current. Such a procedure may be time consuming and expensive. Further, at runtime, the image sensor may take a period of time to reach the steady state temperature and, therefore, it may be difficult to produce an accurate dark shading model. It may be desirable to calibrate a dark shading model at runtime that approximates the dark signal throughout the pixels in the image sensor.

### SUMMARY

At least one example embodiment relates to a method of compensating for a dark signal.

In at least one embodiment, the method includes generating a dark signal model from a measurement of a dark signal in a dark frame, the dark frame captured by an image sensor when shielded from exposure to light; and estimating the dark signal present in an object signal using the dark signal model, the object signal being a digital signal representing an object frame captured by the image sensor when exposed to light.

In at least one embodiment, the method includes capturing the dark frame when a shutter covering the image sensor is closed; and capturing the object frame when a shutter covering the image sensor is open.

In at least one embodiment, the method includes removing the dark signal from the object signal to generate a compensated object signal.

In at least one embodiment, a new dark signal model is generated if the image sensor captures a new object frame.

In at least one embodiment, the generating the dark signal model includes, measuring the dark signal at different pixel locations in the image sensor; and describing the measured dark signal in the dark signal model as a function of the pixel locations, an exposure time at the pixel locations and model parameters.

In at least one embodiment, the model parameters are polynomial coefficients and the describing the measured dark signal in the dark signal model includes, determining a least squares polynomial that represents the dark signal; and determining the polynomial coefficients of the least squares polynomial such that the least squares polynomial represents the measured dark signal.

In at least one embodiment, the method includes scaling the measurement of the dark signal by an inverse of one of an exposure time and a gain, the exposure time and the gain varying based on the pixel location; and scaling the polynomial coefficients by one of the exposure time and the gain.

In at least one embodiment, the dark signal model is represented as one of a linear combination of orthogonal polynomials and the describing the measured dark signal in the dark signal model includes inverting diagonal elements of a covariance matrix containing the model parameters therein and a linear combination of orthonormal polynomials and the describing the measured dark signal in the dark signal model includes using non-inverted elements of a covariance matrix that is an identity matrix containing the model parameters therein.

In at least one embodiment, for each pixel in the dark frame, a corresponding measurement of the dark signal is sequentially provided in a pipeline, and the generating the dark signal model includes iteratively updating the dark signal model based on the sequentially received measurements of the dark signal.

At least one example embodiment relates to a digital signal processor configured to compensate for dark signal in an image signal.

In at least one embodiment, the processor includes a dark signal modeling unit configured to generate a dark signal model from a dark signal, the dark signal being a digital signal representing a dark frame captured by an image sensor when shielded from exposure to light; and a dark signal estimation unit configured to estimate the dark signal present in an object signal using the dark signal model, the object signal being a digital signal representing an object frame captured by the image sensor when exposed to light.

In at least one embodiment, the processor is further configured to, capture the dark frame when a shutter covering the image sensor is closed; and capture the object frame when a shutter covering the image sensor is open.

In at least one embodiment, the processor is further configured to, remove the dark signal from the object signal to generate a compensated object signal.

In at least one embodiment, the processor is configured to generate the dark signal model by, measuring the dark signal at different pixel locations in the image sensor; and describing the measured dark signal in the dark signal model as a function of the pixel locations, an exposure time at the pixel locations and model parameters.

In at least one embodiment, for each pixel in the dark frame, a corresponding measurement of the dark signal is sequentially provided in a pipeline to the processor, and the processor is configured to generate the dark signal model by iteratively updating the dark signal model based on the sequentially received measurements of the dark signal.

At least one example embodiment relates to an image sensing device.

In at least one embodiment, the image sensing device includes a processor configured to compensate for dark signal by, generating a dark signal model from a dark signal, the dark signal being a digital signal representing a dark frame captured by an image sensor when shielded from exposure to light, and estimating the dark signal present in an object signal using the dark signal model, the object signal being a digital signal representing an object frame captured by the image sensor when exposed to light; and an image sensor including a pixel array configured to capture the dark frame and the object frame.

In at least one embodiment, the image sensing device includes a shutter configured to selectively block the pixel array from light exposure under the control of the processor.

In at least one embodiment, the processor is further configured to, capture the dark frame when a shutter covering the image sensor is closed; and capture the object frame when a shutter covering the image sensor is open.

In at least one embodiment, the processor is further configured to remove the dark signal from the object signal to generate a compensated object signal.

In at least one embodiment, the processor is configured to generate the dark signal model by, measuring the dark signal at different pixel locations in the image sensor; and describing the measured dark signal in the dark signal model as a function of the pixel locations, an exposure time at the pixel locations and model parameters.

At least one example embodiment relates to a non-transitory computer readable medium including a computer program.

In at least one embodiment, the computer program includes computer program instructions configured to implement the method of compensating for a dark signal when executed by a processor.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the embodiments.

FIG. 1 is a schematic block diagram of an image sensing system including an image sensor and a digital signal processor according to an example embodiment;

FIG. 2 illustrates a schematic block diagram of an image processing block included in digital signal processor according to an example embodiment;

FIG. 3 illustrates a flow chart of a method of compensating for dark signals in an image sensor according to an example embodiment;

FIGS. 4A and 4B illustrate generating a low resolution version of a dark frame according to an example embodiment;

FIG. 5 a dark signal modeling unit calculating model parameters in a pipeline manner according to an example embodiment; and

FIG. 6 illustrates user equipment according to an example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

While example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional operations not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be any non-transitory storage medium such as magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

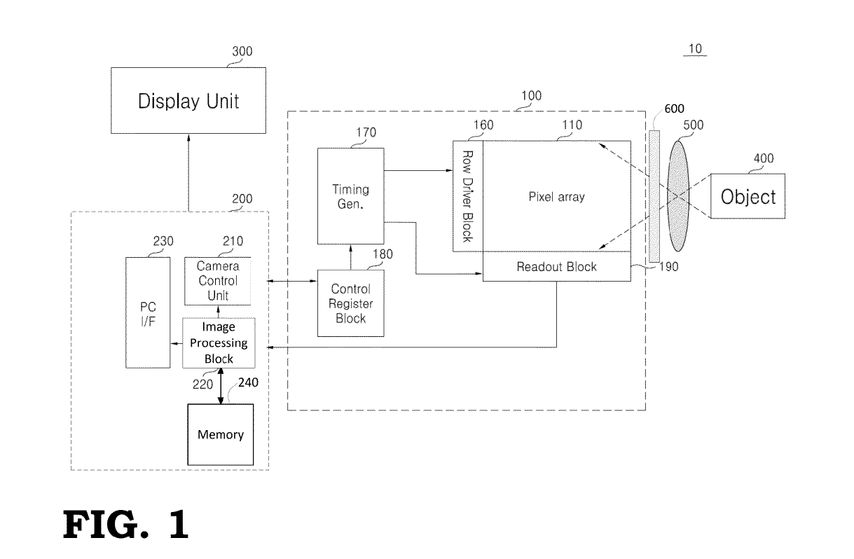

FIG. 1 is a schematic block diagram of an image sensing system including an image sensor and a digital signal processor according to an example embodiment.

Referring to FIG. 1, an image sensing system 10 may include an image sensor 100, a digital signal processor 200, a display unit 300, a lens 500 and/or a shutter 600.

The image sensing system 10 may be used in a digital camera or a digital camera-equipped portable device such as mobile user equipment. The image sensing system 10 may sense an image of an object 400 input through the lens 500 when the shutter 600 is open according to a control of the digital signal processor 200. Further, the image sensing system 10 may sense an image of darkness when the shutter 600 is closed.

The image sensor 100 may include a pixel array 110, a row driver 120, a timing generator driver 170, a control register block 180 and a readout block 190. However, example embodiments are not limited thereto, and the image sensor 100 does not necessarily need to have a row based operation.

The pixel array 110 may include a plurality of pixels in which a plurality of rows and columns are arranged in a matrix form. However, example embodiments are not limited thereto, and the pixels may be arranged in forms other than a matrix. The pixel array 110 senses light using a plurality of photoelectric conversion elements (e.g., a photo diode or a pinned photo diode) and converts the light into an electrical signal, thereby generating an image signal.

Each of the plurality of pixels may include a color filter. For example, the color filter may be a red filter passing light in a red wavelength region, a green filter passing light in a green wavelength region, or a blue filter passing light in a blue wavelength region. However, example embodiments may not require the use of color filters and, therefore, such filters may be omitted.

The digital signal processor 200 may include a camera controller 210, an image processing block 220, an interface (I/F) 230 and a memory 240.

The camera controller 210 may control the image sensor 100 via the control register block 180 using an inter-integrated circuit (I²C); however, example embodiments are not restricted thereto.

The image processing block 220 may generate an image by processing the image signal which is output by the image sensor 100 in digital form, and output the generated image to a display unit 300 via the interface (I/F) 230 and/or store the generated image in the memory 240. Further, the generated image may be provided to an image signal processor (not shown) to further process the generated image. The display unit 300 may include all devices capable of displaying an image.

The timing generator 170 may control the row driver block 160 and the readout block 190 by outputting corresponding control signals thereto.

The control register block 180 may control an operation of image sensor according to a control of the camera controller 210.

The row driver 160 may drive a row of the pixel array 110 by generating a row selection signal based on a row control signal generated by the timing generator 170.

The pixel array 110 may output a pixel signal from the driven row selected by the row selection signal and the gate selection signal, which are provided from the row driver block 160, to the readout block 190, respectively.

However, the image sensor 100 may not process the pixel signal via a line based operation and, therefore, various other control units other than or in addition to the row driver 160 may be utilized.

The readout block 190 temporarily stores the pixel signal from the pixel array 110 and may include an analog-to-digital converter that converts the pixel signals to a digital image and outputs the converted digital image to the image signal processor 220.

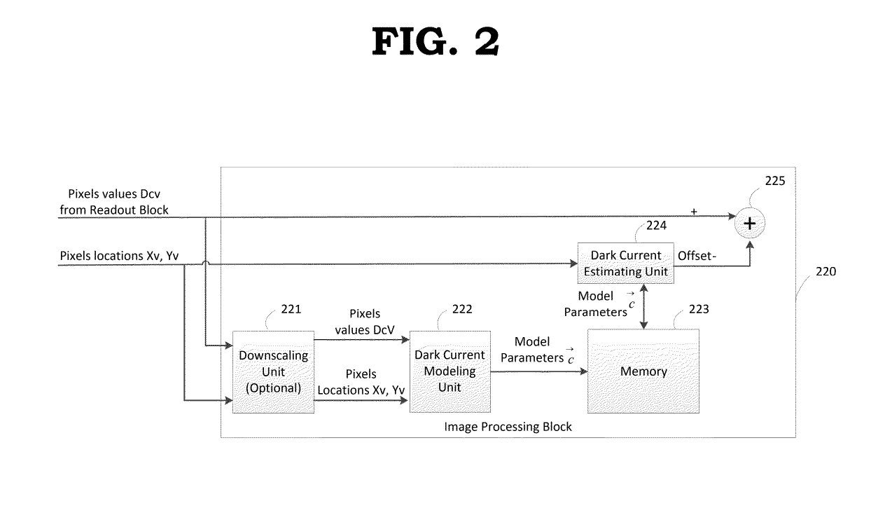

FIG. 2 illustrates a schematic block diagram of an image processing block included in digital signal processor according to an example embodiment.

Referring to FIGS. 1 to 2, the image processing block 220 may include a downscaling unit 221, a dark signal modeling unit 222, a memory 223, a dark signal estimation unit 224 and a compensating unit 225.

It should be also understood that the image processing block 220 may include features not shown in FIG. 2 and should not be limited to those features that are shown. Further, while the downscaling unit 221, the dark signal modeling unit 222, the memory 223, the dark signal estimation unit 224, and the compensating unit 225 are illustrated as being within the image processing block 220, they may be embodied outside of the image processing block 220.

The dark signal modeling unit 222, the dark signal estimation unit 224 and the compensating unit 225 may include any devices capable of processing image data including, for example, a microprocessor configured to carry out specific operations based on input data, or capable of executing instructions included in computer readable code. The computer readable code may be stored on, for example, the memory 223.

The memory 223 may be any device capable of storing data including magnetic storage, flash storage, etc. The memory 223 may be part of the dark signal modeling unit 222 or it may be physically situated on an external device.

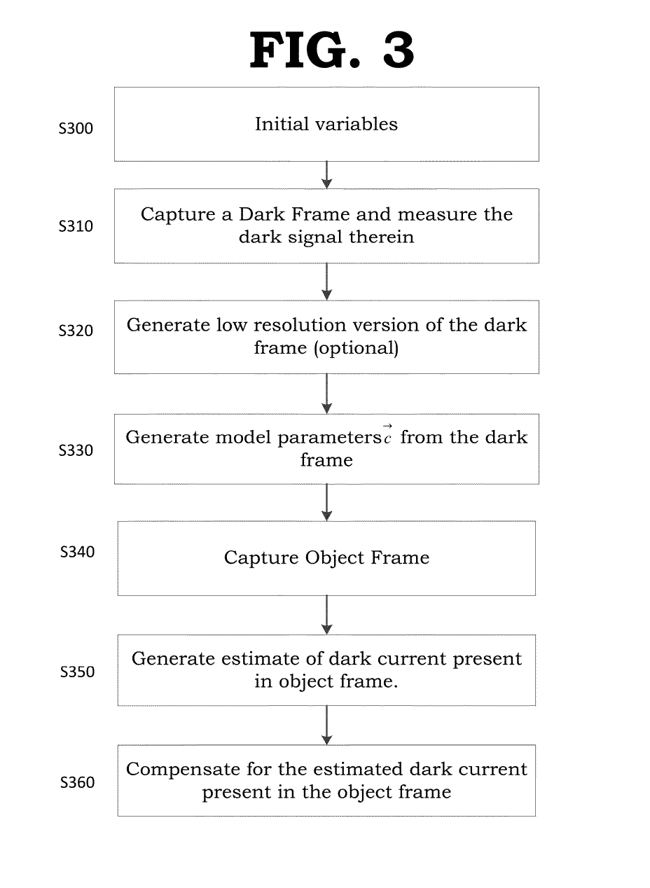

FIG. 3 illustrates a flow chart of a method of compensating for dark signals in an image sensor according to an example embodiment.

Referring to FIGS. 1-3, as illustrated in FIG. 3, the image sensing system 10 may generate a dark signal model and compensate for a dark signal using the generated dark signal model.

In operation 300, prior to receiving pipelined pixels of a digital image of a captured dark frame, the dark signal modeling unit 222 may initialize various variables discussed herein.

In operation S310, the dark signal modeling unit 222 may receive the digital image of a captured dark frame from the readout block 190. The dark frame may be captured by the image sensor 100 when the pixel array 110 is shielded from light, for example, when the shutter 600 is closed. The pixels of the digital image may be provided to the dark signal modeling unit 222 one at a time in a pipeline manner.

Optionally, in operation S320, the downscaling unit 221 may generate a low resolution version of the dark frame. More specifically, the downscaling unit 221 may average groups of pixels and and/or subsample certain pixels within the frame to generate the low resolution version of the dark frame.

The downscaling unit 221 may average the pixels using a binning procedure to combine clusters of pixels. Alternatively, the downscaling unit 221 may subsample the pixels by selecting certain pixels throughout the array as sample pixels that can be utilized to generate a model to approximate the dark signal of neighboring pixels.

The downscaling may reduce an amount of computation and noise. Once the downscaled value of a pixel is computed, the downscaled value can be used for the model creation and any memory required to calculate the downscaled value can be freed.

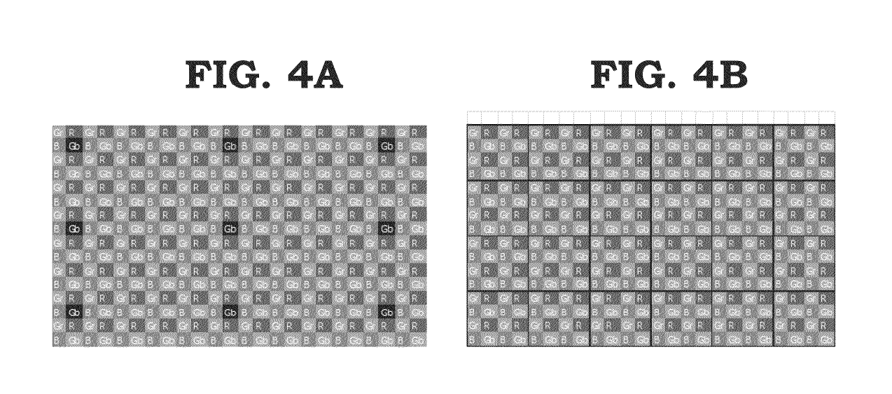

FIGS. 4A and 4B illustrates generating a low resolution version of a dark frame according to an example embodiment.

As illustrated in FIG. 4A and 4B, a color filter array over the pixel array 110 may have a pattern. For example, the pixel array 110 may have a Bayer pattern, in which each pixel in the array may be one of a Red (R), Blue (B), and Green (Gr and Gb) pixels. However, example embodiments are not limited thereto and the pixel array 110 may have various other patterns or no color filters at all.

FIG. 4A illustrates an example of subsampling pixels within the pixel array 110. More specifically, in the example of FIG. 4A, the downscaling unit 221 may select Gb pixels spaced every 10 pixel columns apart and 6 pixel rows apart, as indicated by the black Gb pixels, as pixels to subsample the dark signal flowing therethrough. However, one of ordinary skill will appreciate that certain pixels in any pattern may be selected as the pixels to subsample. For example, the downscaling unit 221 may select pixels from different channels such that an equal number of Red (R), Blue (B), and Green (Gr and Gb) pixels are selected for sampling through the pixel array 110. Alternatively, the downscaling unit 221 may randomly or pseudo randomly select pixels to avoid artifacts that may be caused by uniform sampling.

FIG. 4B illustrates an example of averaging pixels within the pixel array 110. More specifically, in the example of FIG. 4B, the pixel array 110 may be divided into regions indicated by the dark squares. Within each region, the downscaling unit 221 may average the dark signal flowing through the pixels.

Returning to FIG. 3, in operation S330, the dark signal modeling unit 222 may generate parameters to tune a model using the captured dark frame or low resolution version thereof such that the parameters sufficiently represent an estimate of the dark signal. The generation of the dark signal model will be discussed in more detail below. The dark signal modeling unit 222 may store the generated parameters in the memory 223.

The parameters generated for dark signal model may sufficiently describe the dark signal at various pixels x,y within the frame for a certain integration time. By describing the dark signal in the form of a model that can be solved for different pixels x,y within the frame, a frame buffer may not be required. Further, by automatically generating the dark signal model at runtime, the image sensing system 10 may not require custom calibrated and may be sensitive to the temperature of the image sensor 100. Therefore, the image sensing system 10 may reduce a relative size and cost associated with manufacturing the image sensing system 10.

In operation S340, the dark signal estimation unit 222 may receive a digital image of a captured object frame from the readout block 190. The object frame may be captured by the image sensor 100 when the pixel array 110 is exposed to light through the lens 500, for example, when the shutter 600 is open.

In operation S350, the dark signal estimation unit 222 may generate an estimate of the dark signal, dark current, or any other signal present other than the image signal, for different pixel locations and other varying parameters (for example, exposure time and gain) by reading the generated parameters from the memory and applying the parameters to the model based on the location of the pixel. The estimate of the dark signal may be used as an offset to correct noise imparted into object frame due to the presence of dark current.

In operation S360, the compensating unit 228 may compensate for the dark current by subtracting the estimate of the dark signal from the signal representing the object frame, thereby compensating for the dark signal to produce a compensated object signal.

Operations S340 to S360 may be iteratively performed for subsequently captured frames without regenerating the parameters of the dark signal model. Alternatively, the dark signal modeling unit 222 may perform operation S330 and re regenerate the parameters of the model at different intervals, for example, between a certain number of captured object frames and/or after a certain period of elapsed time.

### Tuning of the Dark Signal Model

As discussed above, in operation S330, the dark signal modeling unit 222 may generate parameters to tune a dark signal model using the captured dark frame or low resolution version thereof such The dark signal model may be generated by describing the dark signal in the form of an expression. In the example given herein the dark signal is described in the form of a polynomial expression, for example, a standard or an orthogonal polynomial expression. However, one of ordinary skill in the art will appreciate that the dark signal may be expressed in other forms. For example, the dark signal may be expressed as a Spline or a Trigonometric polynomial. However, example embodiments are not limited thereto.

The dark signal may be described by the standard polynomial expression:

DC(x, y, e)=e(x, y)ΣᵢΣᵢcᵢⱼxⁱy^{j} Eq. (1)

where, x,y is the coordinate of the pixel, e is the exposure time of the pixel x,y, also known as the integration time, and cᵢⱼ is the model parameters which when expressed as a polynomial are the coefficients of the polynomial.

In Eq. (1), the coordinates x,y of each of the pixels and their corresponding integration time may be known, leaving the model parameters cᵢⱼ as the unknown variable.

It is noted that in Eq. 1, a relatively short integration time e can be used when tuning the dark signal model because the dark signal DC is proportional to the integration time e. Therefore, the dark signal DC can be compensated relatively quickly when compared to conventional dark signal compensation techniques.

In an array of n pixels, equation (1) can be expanded as:

$$D C ( {x}_{k} , {y}_{k} , e ( {x}_{k} , {y}_{k} ) ) = e ( {x}_{k} , {y}_{k} ) {\sum }_{i} {\sum }_{j} {c}_{ij} {x}_{k}^{i} {y}_{k}^{j} , \\ k = 1 , 2 , … , n \qquad Eq . ( 2 )$$

The left hand side of Eq. 2, namely DC(xₖ, yₖ, e) may be known since it is simply the measured value of the current from a pixel x,y over an integration time e when the pixel x,y is not exposed to light. More specifically, DC(xₖ, yₖ, e) may be the current measured by the dark signal modeling unit 222 in operation 310.

A normalized model of the dark signal DC of Eq. 2 may be expressed by dividing both sides by the integration time e. By normalizing the dark signal model of Eq. 2, the dark signal modeling unit 222 can calibrate the model using a short integration time and thereafter compensate for a longer exposures by scaling the model.

More specifically, the normalized model may be expressed as:

$$( {x}_{k} , {y}_{k} ) = D C ( {x}_{k} , {y}_{k} , e ( {x}_{k} , {y}_{k} ) ) / e ( {x}_{k} , {y}_{k} ) = {\sum }_{i} {\sum }_{j} {c}_{ij} {x}_{k}^{i} {y}_{k}^{j} \\ where k = 1 , 2 , … , n \qquad Eq . ( 3 )$$

Equation 3 can be expressed in matrix form as:

\vec{DC}=A*\vec{c} Eq. (4)

when dealing with second order polynomials (e.g. when 0≦i,j≦2), \vec{DC}, A and \vec{c} represent the following matrices:

$${D C}^{} = [ \begin{matrix} ( {x}_{1} , {y}_{1} ) \\ ( {x}_{2} , {y}_{2} ) \\ ⋮ \\ ( {x}_{n} , {y}_{n} )\end{matrix} ]$$

$$A = [ \begin{matrix}1 & {x}_{1} & {y}_{1} & {x}_{1}^{2} & {x}_{1} {y}_{1} & {y}_{1}^{2} \\ 1 & {x}_{2} & {y}_{2} & {x}_{2}^{2} & {x}_{2} {y}_{2} & {y}_{2}^{2} \\ ⋮ & ⋮ & ⋮ & ⋮ & ⋮ & ⋮ \\ 1 & {x}_{n} & {y}_{n} & {x}_{n}^{2} & {x}_{n} {y}_{n} & {y}_{n}^{2}\end{matrix} ]$$

$${c}^{->} = [ \begin{matrix}{c}_{00} \\ {c}_{10} \\ {c}_{01} \\ {c}_{20} \\ {c}_{11} \\ {c}_{02}\end{matrix} ]$$

For a large pixel array, the number of coefficients in the system of eq. 4 may be overdetermined. Therefore, a robust optimization method may be utilized to determine the model parameters. For example, a least squares fit may be utilized to determine the model parameters.

The least squares solution of the system of eq. 4 may be defined as the solution of the system:

A^{t}*\vec{DC}=(A^{t}A)*\vec{c} Eq. (5)

Where A^{t} is the transpose of matrix A.

In equation 5, A, A^{t} and the dark signal \vec{DC} are known, leaving the unknown variable of equation 5 as the coefficient c. For a pixel θ in a stream of received pixels from 0 to n, the known equations, A^{t}*\vec{DC} and (A^{t}A), may be updated as:

$$\begin{matrix}{( {A}^{t} A )}_{υ} = {( {A}^{t} A )}_{υ - 1} + {M}_{υ} \\ W here \\ {M}_{ϑ} = [ \begin{matrix}1 & {x}_{ϑ} & {y}_{ϑ} & {x}_{ϑ}^{2} & {x}_{ϑ} {y}_{ϑ} & {y}_{ϑ}^{2} \\ {x}_{ϑ} & {x}_{ϑ}^{2} & {x}_{ϑ} {y}_{ϑ} & {x}_{ϑ}^{3} & {x}_{ϑ}^{2} {y}_{ϑ} & {x}_{ϑ} {y}_{ϑ}^{2} \\ {y}_{ϑ} & {x}_{ϑ} {y}_{ϑ} & {y}_{ϑ}^{2} & {x}_{ϑ}^{2} {y}_{ϑ} & {x}_{ϑ} {y}_{ϑ}^{2} & {y}_{ϑ}^{3} \\ ⋮ & ⋮ & ⋮ & ⋮ & ⋮ & ⋮\end{matrix} ] & Eq . ( 6 ) \\ {( {A}^{t} \cdot {D}^{->} C )}_{υ} = {( {A}^{t} \cdot {D}^{->} C )}_{υ - 1} + {B}_{υ} \\ Where \\ {{B}_{ϑ}}^{} = [ \begin{matrix}D {C}_{ϑ} \\ {x}_{ϑ} D {C}_{ϑ} \\ {y}_{ϑ} D {C}_{ϑ} \\ {x}_{ϑ}^{2} D {C}_{ϑ} \\ {x}_{ϑ} {y}_{ϑ} D {C}_{ϑ} \\ {y}_{ϑ}^{2} D {C}_{ϑ}\end{matrix} ] & Eq . ( 7 )\end{matrix}$$

The values of A^{t}A and A^{t}\vec{DC}, may be iteratively calculated as the dark signal modeling unit 222 receives pixel signals from each of the pixels θ. Thus, allowing the least squares solution of Eq. 5 to be computed in a pipeline type processing system without utilizing a image buffer within the image sensing system 10.

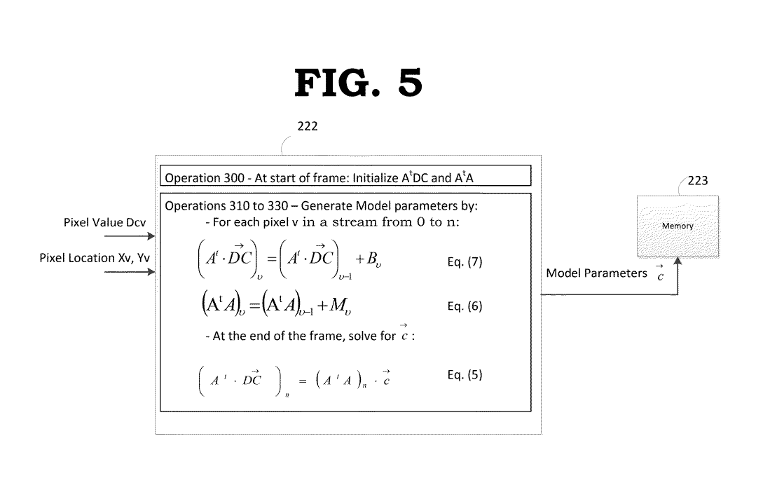

FIG. 5 illustrates a dark signal modeling unit calculating model parameters in a pipeline manner according to an example embodiment.

Referring to FIGS. 2, 3 and 5, for each pixel θ in a stream of received pixels from 0 to n representing a frame, the modeling unit 222 may process each of the pixels in a pipeline manner utilizing a pixel value DC_{θ}, and location X_{θ}, Y_{θ} for the pixel θ to generate the model equations.

In operation 300, prior to receiving the pipelined pixels, the dark signal modeling unit 222 may initialize the values of A^{t}DC and A^{t}A to zero. Thereafter, in operations 310 to 330, for each of the pixels θ in the pipeline, the dark signal modeling unit 222 may update the stored values of A^{t}DC and A^{t}A by applying equations 6 and 7. At the end of the frame, when θ=n, the dark signal modeling unit 222 may generate the model parameters \vec{C} by applying equations 6 and 7 to equation 5 and solve it. Alternatively, rather than generating the model parameters \vec{C} at the end of the frame, the dark signal modeling unit 222 may generate the model parameters periodically at desired (or alternatively, a predetermined) values of the pixels in the index θ. The generated model parameters may be stored in the memory 223 and used to estimate the dark signal present in a subsequent frame that is exposed to light.

Once the normalized dark signal [symbol] (xₖ, yₖ) is calculated using equation 3, the dark signal model DC(xₖ, yₖ, e) that accounts for integration time may be determined as:

DC(xₖ, yₖ, e)= [symbol] (xₖ, yₖ)*e Eq. (8)

The memory requirements to construct Eq. 5 is on the order Q(Q+1) where Q is number of coefficients of the model. However, because the covariance matrix A^{t}A is symmetric, only half of the entries (above or below and including the main diagonal) may need to be stored. Therefore, the memory requirements may be O([Q+3]/2).

Alternatively, instead of describing the dark signal by the standard polynomial expression of Eq. 1 having a combination of monomials xⁱy^{j} that approximate the dark signal, the dark signal may be described as an orthogonal polynomial expression. By expressing the dark signal in the form of an orthogonal polynomial the non-diagonal elements of the covariance matrix A^{t}A become zero, therefore, these elements do not need to be calculated or maintained in memory. Further, if the polynomials are normalized in advance, A^{t}A becomes the identity matrix (i.e. A^{t}Ax=x for all x).

Because the covariance matrix A^{t}A is the identity matrix, equation five (5) is simplified providing the model parameters \vec{c} without having to solve for the least squares solution. More specifically, equation (5) is simplified as:

A^{t}*\vec{DC}=\vec{c} Eq. (9)

The required memory utilized to construct equation (9) is O(Q), and the calculations required are on the order O(nQ) where Q is number of coefficients and n is the number of pixels used to build the model.

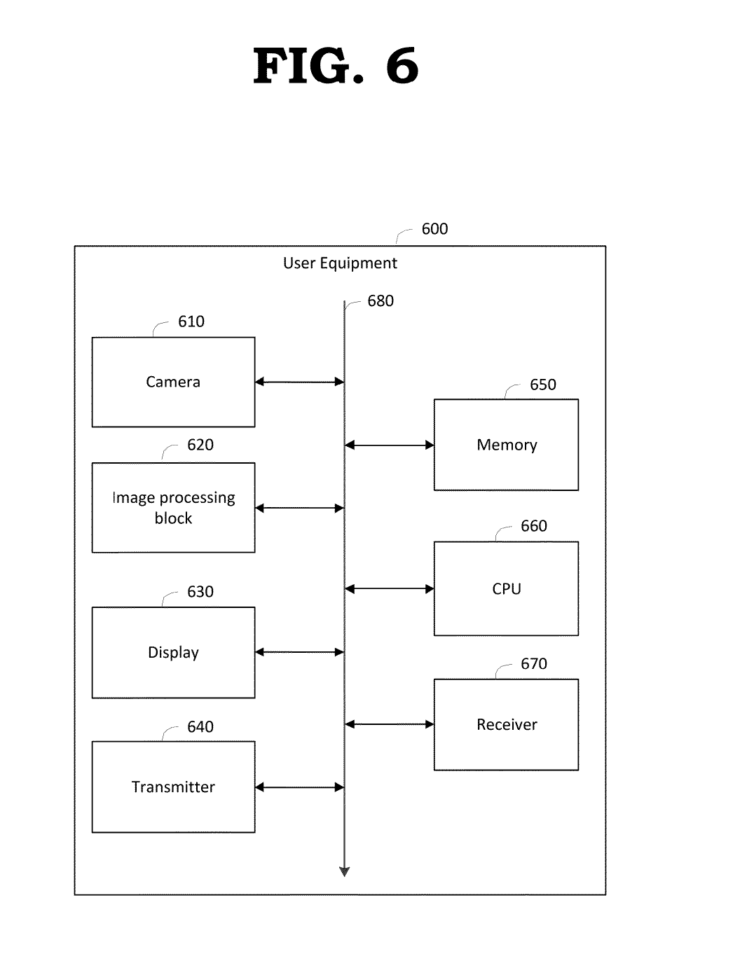

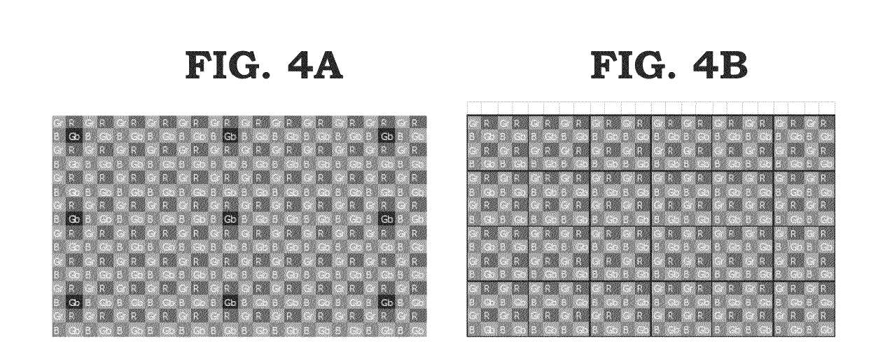

FIG. 6 illustrates user equipment according to an example embodiment.

Referring to FIG. 6, a user equipment 600 may include a camera 610, an image processing block 620, a display 630, a transmitter 640, a memory 650, a Central Processing Unit (CPU) 660, a receiver 670 and a data bus 680 that handles communication therebetween.

The camera 610 may sense an image of an object input through a lens and convert the sensed image into a digital image. Further, the camera 610 may sense an image of a dark frame captured when the pixel array 110 is shielded from light, for example, when the shutter 600 of the camera 610 is closed.

The image processing block 620 may include a dark signal modeling unit that is configured to generate a dark signal model and a dark signal estimating unit to compensate for dark signal using the generated dark signal model to produce a compensated image. The display unit 630 may display the compensated image to a user under the control of the CPU 660. The camera 610, the image processing block 620, the display unit 630 and the memory 650 may represent the image sensing system 10 of FIG. 1.

The transmitter 640 and receiver 670 may transmit and receive signals, respectively under the control of the CPU 660. The transmitter 640 and receiver 670 may include hardware and any necessary software for transmitting and receiving wireless signals, respectively, including, for example, data signals, control signals, and signal strength/quality information via one or more wireless connections to other network elements.

While example embodiments have been particularly shown and described, it will be understood by one of ordinary skill in the art that variations in form and detail may be made therein without departing from the spirit and scope of the claims.

We claim:

1. A method of compensating for a dark signal, the method comprising:
generating a dark signal model from a measurement of the dark signal in a dark frame, the dark frame captured by an image sensor when shielded from exposure to light; and
estimating the dark signal present in an object signal using the dark signal model, the object signal being a digital signal representing an object frame captured by the image sensor when exposed to light.

2. The method of claim 1, further comprising:
capturing the dark frame when a shutter covering the image sensor is closed; and
capturing the object frame when a shutter covering the image sensor is open.

3. The method of claim 1, further comprising:
removing the dark signal from the object signal to generate a compensated object signal.

4. The method of claim 3, wherein a new dark signal model is generated if the image sensor captures a new object frame.

5. The method of claim 1, wherein the generating the dark signal model includes,
measuring the dark signal at different pixel locations in the image sensor; and
describing the measured dark signal in the dark signal model as a function of the pixel locations, an exposure time at the pixel locations and model parameters.

6. The method of claim 5, wherein the model parameters are polynomial coefficients and the describing the measured dark signal in the dark signal model includes,
determining a least squares polynomial that represents the dark signal; and
determining the polynomial coefficients of the least squares polynomial such that the least squares polynomial represents the measured dark signal.

7. The method of claim 5 further comprising:
scaling the measurement of the dark signal by an inverse of one of an exposure time and a gain, the exposure time and the gain varying based on the pixel location; and
scaling the polynomial coefficients by one of the exposure time and the gain.

8. The method of claim 5, wherein the dark signal model is represented as one of,
a linear combination of orthogonal polynomials and the describing the measured dark signal in the dark signal model includes inverting diagonal elements of a covariance matrix containing the model parameters therein, and
a linear combination of orthonormal polynomials and the describing the measured dark signal in the dark signal model includes using non-inverted elements of a covariance matrix that is an identity matrix containing the model parameters therein.

9. The method of claim 1, wherein for each pixel in the dark frame, a corresponding measurement of the dark signal is sequentially provided in a pipeline, and the generating the dark signal model includes iteratively updating the dark signal model based on the sequentially received measurements of the dark signal.

10. A digital signal processor configured to compensate for a dark signal in an image signal, the processor comprising:
a dark signal modeling unit configured to generate a dark signal model from the dark signal, the dark signal being a digital signal representing a dark frame captured by an image sensor when shielded from exposure to light; and
a dark signal estimation unit configured to estimate the dark signal present in an object signal using the dark signal model, the object signal being a digital signal representing an object frame captured by the image sensor when exposed to light.

11. The processor of claim 10, wherein the processor is further configured to,
capture the dark frame when a shutter covering the image sensor is closed; and
capture the object frame when a shutter covering the image sensor is open.

12. The processor of claim 10, wherein the processor is further configured to,
remove the dark signal from the object signal to generate a compensated object signal.

13. The processor of claim 10, wherein the processor is configured to generate the dark signal model by,
measuring the dark signal at different pixel locations in the image sensor; and
describing the measured dark signal in the dark signal model as a function of the pixel locations, an exposure time at the pixel locations and model parameters.

14. The processor of claim 10, wherein, for each pixel in the dark frame, a corresponding measurement of the dark signal is sequentially provided in a pipeline to the processor, and
the processor is configured to generate the dark signal model by iteratively updating the dark signal model based on the sequentially received measurements of the dark signal.

15. An image sensing device comprising:
a processor configured to compensate for a dark signal by,
generating a dark signal model from the dark signal, the dark signal being a digital signal representing a dark frame captured by an image sensor when shielded from exposure to light, and
estimating the dark signal present in an object signal using the dark signal model, the object signal being a digital signal representing an object frame captured by the image sensor when exposed to light; and
an image sensor including a pixel array configured to capture the dark frame and the object frame.

16. The image sensing device of claim 15, further comprising:
a shutter configured to selectively block the pixel array from light exposure under the control of the processor.

17. The image sensing device of claim 15, wherein the processor is further configured to,
capture the dark frame when a shutter covering the image sensor is closed; and
capture the object frame when a shutter covering the image sensor is open.

18. The image sensing device of claim 15, wherein the processor is further configured to,
remove the dark signal from the object signal to generate a compensated object signal.

19. The image sensing device of claim 15, wherein the processor is configured to generate the dark signal model by,
measuring the dark signal at different pixel locations in the image sensor; and
describing the measured dark signal in the dark signal model as a function of the pixel locations, an exposure time at the pixel locations and model parameters.

20. A non-transitory computer readable medium including a computer program comprising:
computer program instructions configured to implement the method of claim 1 when executed by a processor.
